(19) United States
(12) Patent Application Publication
(10) Pub. No.: US 2024/0254362 A1
(43) Pub. Date: Aug. 1, 2024

(54) POLYMER MATERIALS FUNCTIONALIZED WITH BASIC SALTS

(71) Applicant: Workers First LLC, Pittsburgh, PA (US)

(72) Inventors: Matthew James Borowiak, JR., Buffalo, NY (US); Richard Earl Partch, Hannawa Falls, NY (US)

(73) Assignee: Workers First LLC, Pittsburgh, PA (US)

(21) Appl. No.: 18/428,493

(22) Filed: Jan. 31, 2024

Related U.S. Application Data
(60) Provisional application No. 63/482,666, filed on Feb. 1, 2023.

(51) Int. Cl. C09D 177/00; C08G 69/48; D06M 13/207; D06M 15/59; D06M 23/00; D06M 101/34

(52) U.S. Cl. CPC C09D 177/00; C08G 69/48; D06M 13/207; D06M 15/59; D06M 23/00; C08G 2150/00; D06M 2101/34; D06M 2200/00

(57) ABSTRACT

A modified acid neutralizing polymer material includes a substrate having a surface including an acid neutralizing polymer material and a modified layer formed on the acid neutralizing polymer material surface. The modified layer includes a reaction product between a basic salt solution and the acid neutralizing polymer material surface. A method for preparing the modified acid neutralizing polymer material includes receiving a substrate comprising an acid neutralizing polymer material, applying a basic salt solution to the substrate to create a modified substrate through a reaction product between the basic salt solution and the acid neutralizing polymer material to form the modified acid neutralizing polymer material, allowing the basic salt solution to evaporate from the modified substrate, and optionally, removing unreacted basic salt material from the modified acid neutralizing polymer material.

### CROSS-REFERENCE TO RELATED APPLICATIONS

This application claims the benefit of U.S. patent application Ser. No. 63/482,666, filed on Feb. 1, 2023 and entitled POLYMER MATERIALS FUNCTIONALIZED WITH BASIC SALTS, the contents of which are hereby incorporated by reference in their entirety.

### TECHNICAL FIELD

The present invention relates to a method of making an acid neutralizing polymer, and more particularly to a method of making an acid neutralizing polymer with further modification of the polymer through reaction with a basic salt.

### BACKGROUND OF THE INVENTION

Polyamides, including nylon 6, nylon 6,6 (nylon 66) and nylon 12, are synthetic polymers amenable to functionalization through chemical modification of the amide groups within the polymer backbone. By way of example, nylon fabrics have been modified to increase their tensile strength for military application or modified to improve dye acceptance.

In U.S. Pat. No. 11,078,331 (“the ‘331 Patent”) and U.S. Patent Publication No. 2021/0324140 (“the ‘140 Publication”), the entirety of each being incorporated by reference herein, a process is described to create an acid neutralizing powder through a reaction in dimethyl formamide (DMF). This wet chemistry process has the disadvantage of providing only a low yield and hence the reacted product is limited in the extent to which it can provide the required acid neutralization properties. Additionally, the process by-products (butanol from the reaction and DMF vapor from the drying step) may be difficult to handle from an environmental perspective.

U.S. Patent Publication No. 2022/0289910 (“the ‘910 Application”), the entirety of which is incorporated by reference herein, discloses an alternative process for producing acid neutralizing poly materials through reactive extrusion. While overcoming many of the drawbacks associated with the wet chemistry synthesis, the reactive extrusion system and method described within the ‘910 Publication may be improved upon, such as simplifying the reaction and eliminating potentially harmful or caustic reagents.

Thus, what is needed is an acid neutralizing polymer having a high amide modification which is further modified by reaction with a basic salt to produce a polymer material with increased acid neutralization capacity. The present invention addresses these, as well as other, needs.

### SUMMARY OF THE INVENTION

As described in the ‘331 Patent, and the ‘140 and ‘910 Publications, the Acid Neutralizing Polymer Reaction (ANPR) is a method of creating an acid neutralizing polymer that can be used, for instance and without limitation, to generate both powder and resin in order to serve the Acid Proof Coatings & Lining market and the Personal Protection Equipment (PPE) market. By way of example, these powders may be added to floor coatings and also made into floor mats to protect equipment and personnel by neutralizing acids on contact.

Products manufactured with this technology exceed the performance of corrosion resistant materials such as PVC, PTFE, phenolic epoxy, and rubber floor mats through a combination of acidic corrosion resistance and acid neutralization. In addition, these polymers can be used to neutralize acids multiple times by refreshing them via a proprietary reactivation solution.

Beyond traditional wet chemistry, compounding technology may be used for reacting an amino nylon polymer with additional chemicals within a polymer compounding process such as via a twin-screw extruder, internal mixer, continuous mixer or a reciprocating single screw compounding machine. The compounding reaction involves the melt mixing of the ingredients using an optimized set of process conditions which provide the necessary temperature of reaction, residence time, and degree of shear induced dispersion.

An advantage of the reactive compounding process is that it is possible to generate a much higher yield of the reacted final product. During the reactive compounding process, the reactions take place when the polymer is in the molten state and is undergoing intensive dynamic shear. This allows for intimate mixing of the reactants and optimal reaction yield by controlling temperature (which affects reaction rate) and residence time (which affects the extent of reaction).

By way of example and as set forth more fully in the ‘331 Patent, and/or the ‘140 and ‘910 Publications, reactive compounding can be accomplished in three steps. In the first step, amino nylon is blended with a halogenated-dimethylalkylamine such as 2-chloro-N,N-dimethylethylamine hydrochloride, an acid neutralizing compound such as calcium carbonate, and a heat stabilizer suitable for nylon, such as BRUGGOLEN H10 available from L. Brüggemann GmbH & Co. KG, Heilbronn, Germany. The first step of the reaction neutralizes the 2-chloro-N,N-dimethylethylamine hydrochloride. The second step involves reacting additional amino nylon with calcium hydroxide and a heat stabilizer suitable for nylon. The heat stabilizer may be the same or different than the heat stabilizer using in the first step. The second step generates anionic nitrogen atoms for reaction in the third step. The third step involves the combination of the reaction products generated in the first and second steps to produce the final product. Depending on the particular melt compounding process used, the final product can be produced in multiple steps or in either 2 or 1 steps.

As further described in the ‘331 Patent, and/or the ‘140 and ‘910 Publications, a method of making an acid neutralizing polymer material includes preparing a first reaction mixture comprising a buffering agent and an amine salt of either a halogenated tertiary amine or a haloalkyl heterocyclic aromatic amine. The first reaction mixture is added to a first compounding machine and reacted for a time and at a temperature sufficient to produce a neutralized amine. A second reaction mixture including a polyamide material and a strong base is prepared, added to the first reaction product and reacted for a time and at a temperature sufficient to produce the acid neutralizing polymer material. Alternatively, the buffering agent, amine salt of either a halogenated tertiary amine or a haloalkyl heterocyclic aromatic amine, and the polyamide material may be added and reacted for a time and at a temperature sufficient to produce the acid neutralizing polymer material.

### BRIEF DESCRIPTION OF THE DRAWINGS

The accompanying drawings form a part of this specification and are to be read in conjunction therewith, wherein like reference numerals are employed to indicate like parts in the various views, and wherein:

FIG. 1 is a flowchart of an exemplary method for producing an acid neutralizing polyamide material modified with a basic salt in accordance with the present invention; and

FIG. 2A-2E is a generalized step-wise schematic of an exemplary acid neutralizing polymer modified by addition of a basic salt.

### DETAILED DESCRIPTION

Polyamides, such as but not limited to nylon 6, nylon 66 and nylon 12 may be modified through base-induced removal of the amido hydrogen to generate a reactive nitrogen atom within the polyamide backbone. As described more fully in the ‘331 Patent, and the ‘140 and ‘910 Publications, the nitrogen reacts with a basic compound, such as an amine, to covalently bond a basic pendant group to the polyamide chain. This basic pendant group may then provide a reaction site for further chemical processes, such as neutralizing hydrogen ions (acid) which come into contact with the modified nylon. Alternatively, as will be discussed in greater detail below, the basic pendant group may further react with a basic salt to further modify the nylon surface to increase acid neutralizing reactivity of the material.

As generally disclosed within the ‘331 Patent, and the ‘140 and ‘910 Publications, an acid neutralizing polymer end product may be produced through traditional wet chemistry approaches or through reactive extrusion processes. By way of example, virgin polyamide material may be reacted with a solid, strongly basic material (e.g., a basic salt of a strong base). The virgin polyamide material may become activated by removal of an amide hydrogen on the polyamide polymer backbone. Without limitation thereto, the activated polyamide material may then be reacted with a halogenated-dimethylalkylamine having a general chemical formula of (CH₃)₂N-R-X where R may be an alkyl containing 1-12 carbon atoms and X is either chlorine or bromine. In one particular aspect, the halogenated-dimethylalkylamine is 2-chloro-N,N-dimethylethylamine.

The activated polyamide material and halogenated-dimethylalkylamine are then reacted whereby the activated polyamide material becomes functionalized by the dimethylalkylamine to produce an acid neutralizing polyamide. Additional or alternative process steps and reagents, such as but not limited to an acid neutralizing compound such as calcium carbonate and a heat stabilizing agent, such as but not limited to BRUGGOLEN H10 available from L. Brüggemann GmbH & Co. KG, Heilbronn, Germany, may be included, as necessary, to produce the desired final acid neutralizing polyamide material product.

Additional acid neutralizing polymer materials may be prepared through the use of alternative amine starting reagents. In one specific example, one alternative amine may be a haloalkyl heterocyclic aromatic amine such as 4-(Chloromethyl)pyridine hydrochloride. 4-(Chloromethyl)pyridine hydrochloride may be a suitable reactant because its chain length is similar to that of many nylon monomers, such as nylon 6, nylon 6,6 or nylon 12. Additional alternative amine compounds may include halogenated tertiary amines, such as and without limitation thereto, 4-(Dimethylamino)benzoyl chloride hydrochloride, 2-Dimethylaminoisopropyl chloride hydrochloride, 2-(Diethylamino)ethyl chloride hydrochloride and 6-Chloro-N,N-dipropylhexan-1-amine.

As described, the acid neutralizing polymer material can be made into fabric or mesh or can also be pelletized to be mixed with other polymers. The pellets can also be further ground into powder to be used as an additive in coatings and other building materials such as mortar and polymer concrete in order to impart acid neutralization functionality.

From the above, it should be noted that each of the reactions may take place at any desired temperature, but preferably below the boiling point of the respective materials. Additionally, each reaction may also occur at any desired pressure within the compounding machine. Reaction times will thus depend upon the flow rate of the compounding machine, and the temperature and pressure of each reaction within the compounding machine.

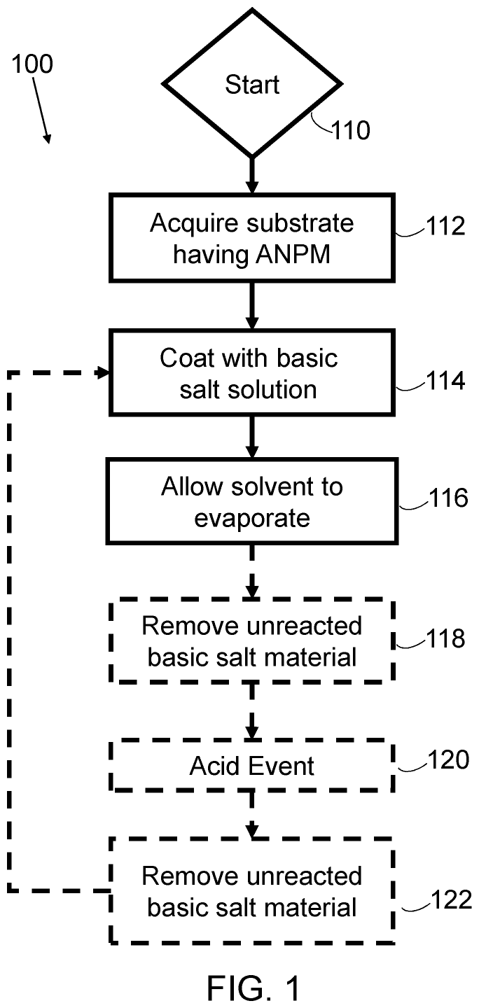

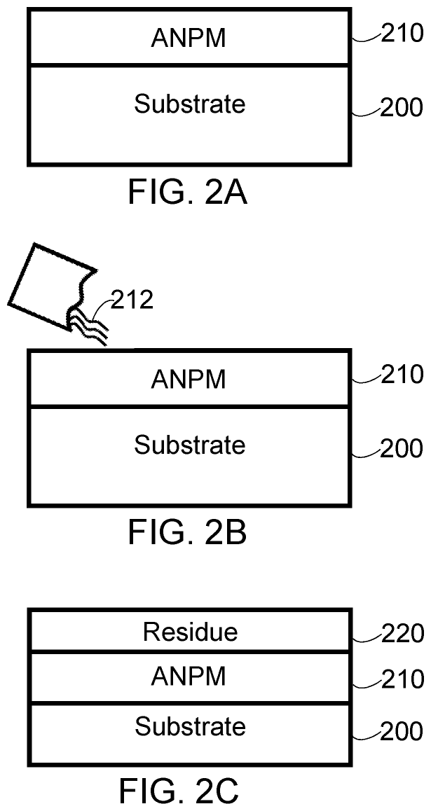

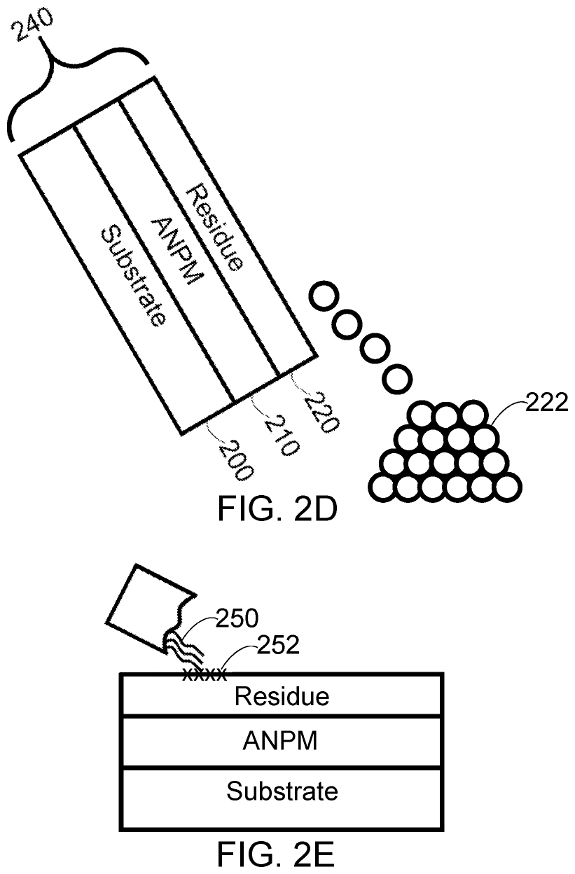

In accordance with an aspect of the present invention, each of the embodiments of an acid neutralizing polymer material produced in accordance with the disclosures of the ‘331 Patent, and the ‘140 and ‘910 Publications may be further modified with a basic salt solution to increase the neutralization efficiency of the polymer material. Turning now to FIGS. 1 and 2A-2E, an exemplary method 100 for modifying an acid neutralizing polymer material starts at step 110 with acquisition of a substrate 200 (FIG. 2A) including the acid neutralizing polymer material layer 210 (FIG. 2A) at step 112. Substrate layer 200 may be any suitable construction, such as but not limited to a fabric (e.g., a textile material that may be used in the construction of articles of clothing, such as a laboratory coat, socks, pants, gloves, diapers, etc.; or within linens, such as blankets, sheets, towels, and the like), a support structure (e.g., a floor mat or pad, mortar, concrete, etc.) or a particle (such as a pellet, powder additive or the like). Without limitation thereto, acid neutralizing polymer material layer 210 may be affixed to or otherwise be incorporated within substrate layer 200 such as through a chemical bond, thermal bonding or an adhesive. Care should be taken to prevent denaturing or blocking of the reactive amide and/or amine sites on the acid neutralizing polymer material when affixing layers 200 and 210 to one another.

At step 114, the acid neutralizing polymer material layer 210 is coated with a solution 212 (FIG. 2B) containing a basic salt. In one exemplary embodiment, the basic salt may comprise an alkali or alkaline earth metal salt of an organic acid, such as but not limited to carboxylic or carbonic acids, and may have a general formula such as M(RCOO)n, Mx(CO₃)y or Mx(HCO₃)y where M is an alkali or alkaline earth metal and subscripts n, x and y are selected to satisfy stoichiometry. The solvent, typically water although other polar solvents may be used, is allowed to evaporate at step 116 which leaves behind a residue layer 220 on the surface of the acid neutralizing polymer material layer 210 (FIG. 2C). Without being limited to any particular theory, it is believed that the basic component of the salt solution is bound to either or both of the amide or amine nitrogens within the polymer backbone or pendant groups of the acid neutralizing polymer material. At optional step 118, unreacted/unbound residual salt 222 is removed from the modified polymer material 240 (comprising the basic salt modified polymer/substrate layers 220/210/200) such as via agitation, tipping or inverting of material 240 (FIG. 2D).

With reference to FIG. 2E and as illustrated generally therein, upon contact with an acidic solution 250 (such as following a spill), e.g. at event 120 (see FIG. 1), the bound basic residue layer 220 on the modified polymer material 240 reacts with the acidic hydrogen ion of acidic solution 250 to neutralize the acid 252 and raise the pH of the solution, thereby rendering the spilled solution less hazardous. The modified acid neutralization performance of the polymer material may then be regenerated (step 122, FIG. 1) by repeating steps 114 and 116 (and optionally step 118) of method 100. In one exemplary embodiment, the polymer material may be regenerated (step 122) via method 100 more than 30 times without appreciable loss of acid neutralization efficiency or physical degradation of the modified polymer material.

The following are representative and non-limiting examples of a modified polymer material evidencing the manufacture and use of a modified acid neutralizing polymer material in accordance with the present invention:

### EXAMPLES

### Experiment 1—Acid Neutralizing Polymer Material (ANPM) Floor Mat

1. Create 250 ml pH 0.3 hydrochloric acid solution.
2. Place a fresh 1 ft by 1 ft ANPM surface-coated floor mat into a secondary containment tray.
3. Pour the solution from Step 1 onto the floor mat of Step 2 to cover the entire surface of the floor mat.
4. Remove the floor mat from the tray and collect the solution from the tray into a beaker.
5. Measure the pH change of the collected solution.

Results—Experiment 1 showed a pH increase from pH 0.3 to pH 0.5. This pH increase is believed to be due to the innate acid neutralizing ability of the ANPM.

### Experiment 2—Modified Acid Neutralizing Polymer Material (mANPM) Floor Mat

1. Create 250 ml pH 0.3 hydrochloric acid solution.
2. Place a fresh 1 ft by 1 ft mANPM surface-coated floor mat into a secondary containment tray.
3. Pour the solution from Step 1 onto the floor mat of Step 2 to cover the entire surface of the floor mat.
4. Remove the floor mat from the tray and collect the solution from the tray into a beaker.
5. Measure the pH change of the collected solution.

Results—Experiment 2 showed that the pH increase from pH 0.3 to pH 6.0. Experiment 2 was repeated ten times where it repeatedly performed this action.

### Experiment 3—Modified Acid Neutralizing Polymer Material (mANPM) Spill Kit

1. Create 2 L pH 0.3 hydrochloric acid solution.
2. Add 500 g by weight of mANPM pellets to the acidic solution of Step 1 and react for 30 seconds.
3. After 30 seconds measure the pH change of the acidic solution.

Results—Experiment 3 showed a pH increase from pH 0.3 to pH 6.3. Experiment 3 was repeated ten times where it repeatedly performed this action.

### Experiment 4—Modified Acid Neutralizing Polymer Material (mANPM) Acid Neutralizing Fabric

1 Create 250 ml pH 0.3 nitric acid solution.
2. Place a fresh 1 ft by 1 ft mANPM fabric into a 500 ml beaker
3. Submerge the mANPM fabric with the solution from Step 1 for 30 seconds while stirring it slightly.
4. After 30 seconds remove the mANPM fabric from the solution.
5. Measure the pH change of the collected solution.

Results—Experiment 4 showed a pH increase from pH 0.3 to pH 8.2. Experiment 4 was repeated ten times where it repeatedly performed this action.

### Experiment 5—Modified Acid Neutralizing Polymer Material (mANPM) Paint/Coating

1. Create 100 ml pH 0.3 nitric acid solution.
2. Place a 8 in×8 in carbon steel mANPM coated paint sample into a secondary containment tray.
3. Pour the solution from Step 1 onto the sample of Step 2 covering the entire surface of the sample.
4. Remove the sample from the tray and collect the liquid solution.
5. Measure the pH change of the collected solution.

Results—Experiment 5 showed a pH increase from pH 0.3 to pH 6.0. Experiment 5 was repeated ten times where it repeatedly performed this action.

### Experiment 6—Re-Application Of Basic Salt Coating To Re-Activate Modified Acid Neutralizing Polymer Material (mANPM)

1. Create a 250 ml pH 0.3 hydrochloric acid solution.
2. Place a sample (see Experiments 2-5) into a secondary containment vessel.
3. Pour the solution from Step 1 onto the sample making sure that the solution covers the entire surface of the sample.
4. Remove sample from the vessel and collect the liquid solution.
5. Measure the pH change of the collected solution.
6. Pour 250 ml of a basic salt solution in accordance with the present invention onto the sample.
7. Allow the sample from Step 6 to dry for 24 hours.
8. Repeat Steps 1-5.
9. Repeat Steps 1-8, as desired.
   Results—Each of the aforementioned products (see Experiments 2-5) are able to be re-activated repeatedly (at least 30 times) and are able to reproducibly neutralize acids each time. The products and processes have also been tested with nitric, sulfuric, lactic, and acetic acids such that modified acid neutralizing polymer material products are usable with both organic and inorganic acids.

Although the invention has been described with reference to preferred embodiments thereof, it is understood that various modifications may be made thereto without departing from the full spirit and scope of the invention as defined by the claims which follow.

What is claimed is:

1. A modified acid neutralizing polymer material comprising:
a substrate having a surface including an acid neutralizing polymer material (ANPM); and
a modified layer formed on the ANPM surface, wherein the modified layer comprises a reaction product between a basic salt solution and the ANPM surface.

2. The modified acid neutralizing polymer material in accordance with claim 1, wherein the substrate comprises a fabric, support structure or a particle.

3. The modified acid neutralizing polymer material in accordance with claim 2, wherein the fabric is incorporated within a textile material for use in an article of clothing or a linen.

4. The modified acid neutralizing polymer material in accordance with claim 2, wherein the support structure is a floor mat.

5. The modified acid neutralizing polymer material in accordance with claim 1, wherein the ANPM comprises a polyamide backbone functionalized by addition of one or more a halogenated-dialkylalkylamine, a haloalkyl heterocyclic aromatic amine, and a halogenated tertiary amine.

6. The modified acid neutralizing polymer material in accordance with claim 5, wherein the ANPM is produced via reactive extrusion.

7. The modified acid neutralizing polymer material in accordance with claim 1, wherein the basic salt solution comprises an alkali or alkaline earth metal salt of an organic acid.

8. The modified acid neutralizing polymer material in accordance with claim 7, wherein the alkali or alkaline earth metal salt of an organic acid is a carboxylic or carbonic acid having a general formula of M(RCOO)n, Mx(CO₃)y or Mx(HCO₃)y, where M is an alkali or alkaline earth metal and subscripts n, x and y are selected to satisfy stoichiometry.

9. A method for preparing a modified acid neutralizing polymer material (mANPM), comprising:
a) receiving a substrate comprising an acid neutralizing polymer material (ANPM);
b) applying a basic salt solution to the substrate wherein a modified substrate is created through a reaction product between the basic salt solution and the ANPM to form the mANPM;
c) allowing the basic salt solution to evaporate from the modified substrate; and
d) optionally, removing unreacted basic salt material from the mANPM.

10. The method in accordance with claim 9, wherein the substrate comprises a fabric, support structure or a particle.

11. The method in accordance with claim 9, wherein the ANPM comprises a polyamide backbone functionalized by addition of one or more a halogenated-dialkylalkylamine, a haloalkyl heterocyclic aromatic amine, and a halogenated tertiary amine.

12. The method in accordance with claim 11, wherein the ANPM is produced via reactive extrusion.

13. The method in accordance with claim 9, wherein the basic salt solution comprises an alkali or alkaline earth metal salt of an organic acid.

14. The method in accordance with claim 13, wherein the alkali or alkaline earth metal salt of an organic acid is a carboxylic or carbonic acid having a general formula of M(RCOO)n, Mx(CO₃)y or Mx(HCO₃)y, where M is an alkali or alkaline earth metal and subscripts n, x and y are selected to satisfy stoichiometry.

15. The method in accordance with claim 9, further comprising:
e) regenerating the mANPM after exposure to an acid by reapplication of the basic salt solution in accordance with steps (b) through (d).
